(19) United States
(12) Patent Application Publication
(10) Pub. No.: US 2016/0346577 A1
(43) Pub. Date: Dec. 1, 2016

(54) AEROSOL FIRE EXTINGUISHING DEVICE FOR INSTALLATION ON MOVING OBJECT, AND AEROSOL FIRE EXTINGUISHING AGENT FOR USE IN SAME

(71) Applicant: Fireaway Inc., Minnetonka, MN (US)

(72) Inventor: Keita Ito, (US)

(21) Appl. No.: 15/107,173

(22) PCT Filed: Dec. 16, 2014
(86) PCT No.: PCT/JP2014/006277

§ 371 Date: Jun. 22, 2016

(30) Foreign Application Priority Data
Dec. 27, 2013 (JP) 2013-270955

(51) Int. Cl. A62C 5/00; A62C 3/07; A62D 1/06

(52) U.S. Cl. CPC A62C 5/006; A62D 1/06; A62C 3/07

(57) ABSTRACT

Provided is an aerosol fire extinguishing device having improved heat resistance and vibration resistance, and designed to be installable in a moving object such as a vehicle, and an aerosol fire extinguishing agent for use in the same. The aerosol fire extinguishing agent is an aerosol fire extinguishing agent comprising an oxidizing agent, a reducing agent, and a reducing agent/binder, to which a fluororubber is added in an outer percentage of 0.5-5 wt %. The aerosol fire extinguishing agent is an aerosol fire extinguishing agent comprising 60-85 wt % of potassium nitrate, 10-26.7 wt % of dicyandiamide, and 5-13.3 wt % of phenolic resin, to which a fluororubber is added in an outer percentage of 0.5-5 wt %. An aerosol tire extinguishing agent pellet is provided with a generally circular disk-shaped pellet press-molded from the aerosol fire extinguishing agent and having in the center thereof a fire extinguishing tool insertion hole, and with a restrictor made of soft rubber applied onto the outer surface of the pellet. The aerosol fire extinguishing device is provided with the aerosol fire extinguishing agent pellet.

### TECHNICAL FIELD

The present invention relates to an aerosol fire extinguishing device that can be mounted on the moving object such as vehicle, and an aerosol fire extinguishing agent for use in the same.

### BACKGROUND

The aerosol fire extinguishing device is conventionally used, for example, to suppress and extinguish the fire occurring in the closed sealed space such as engine room, cable ducts, control panel, equipment housing, and the like.

The aerosol fire extinguishing device has a built-in drug that produces the aerosol fire extinguishing agent by chemical reaction, a coolant, and an ignition device, wherein the drug is composed of metallic potassium oxide, resins, other additives, and the like.

The aerosol fire extinguishing device receives the operating electric signals from the outside, which heats up the drug in the aerosol fire extinguishing device to generate pressure that assists in spraying and producing fine extinguishing and gas components. These products (fine fire-extinguishing components+gas components) are passed through the cooling layer and sprayed through the nozzle. When the sprayed fine fire-extinguishing components are supplied to flames (where it is required to extinguish), the potassium radical of the fine fire-extinguishing components interrupt the chain reaction of the flames (negative catalysis) thereby suppressing the flames.

Hereinafter, the action of fine fire-extinguishing components generated in the aerosol fire extinguishing device in stopping the combustion reaction will be explained. It pertains to the aerosol fire extinguishing agent for use in the same.

Firstly, the combustion radicals [mainly O, H, and OH radical] largely contribute to the combustion, and continuation and expansion of combustion increases the combustion radicals. The combustion radicals generated by combustion generally react with atmospheric oxygen causing reaction in a chain reaction thereby further increasing the number of combustion radicals; therefore, the combustion continues to continue or expand under an environment of fuel, heat, and oxygen.

Next, when the drug is reacted, the fine fire-extinguishing components having potassium radical effective in extinguishing are largely produced and sprayed from the aerosol fire extinguishing device to introduce onto the flame (where it is required to extinguish).

The potassium radicals sprayed from the aerosol fire extinguishing device preferentially couple together with the oxygen radicals in the flame and interfere with combustion reaction, wherein the combustion radicals react with oxygen. The combustion radicals coupled with potassium radicals eventually react with other combustion radicals and convert to a substance such as H₂O. In other words, the combustion radicals in the flame are reduced thereby obstructing the combustion reaction and reducing or extinguishing the flames. At this time, the potassium radicals do not cause any change or chemical combination; therefore, they suppress the flames by continuing obstructing the combustion reaction.

As described above, the aerosol fire extinguishing device can suppress the chain reaction of the combustion by chemical and physical actions by spraying the fire extinguishing agent composed primarily of potassium in the form of ultrafine aerosol on to the generated fire, and the effect thereof can extinguish the fire.

The aerosol fire extinguishing device has extinguishing efficiency several times excellent than the other systems for fire extinguishing particles caused by combustion, which are very small generally 1 to 5 μm. The aerosol fire extinguishing device, unlike the existing gas-based fire-extinguishing devices, also has no piping work and can be easily fixed thereby reducing the installation and maintenance costs.

The aerosol fire extinguishing device also has an advantage such as it can exert excellent effect against oil and electrical fires for which water cannot be used.

As for relevant prior art, for example, Patent documents 1 to 4 and the like are known.

Patent document 1 discloses the fire extinguishing agent of the aerosol fire extinguisher and the manufacturing method thereof, and the fire extinguisher structure.

In Patent document 1, the strength (elasticity) is maintained by using the epoxy resin without a curing agent as the binder for fire extinguishing agent; by using the one which does not cure.

Patent document 2 discloses the details about the various compositions for aerosol fire extinguishing agent, and discloses the technique for producing aerosol fire extinguishing agent by kneading oxidizing and reducing agents with organic solvent and then, casting and heat drying molding the kneaded product.

Patent document 3 discloses the aerosol fire extinguishing device having an aerosol cooling mechanism by air mixture and filled with fire-extinguishing pyrotechnic products into the one side open end tube to ignite by an electric coil.

Patent document 4 discloses the aerosol fire extinguishing agent for which oxygen is compositionally balanced and it is hard to generate harmful gases. The fire extinguishing agent comprises 67 to 72 wt. % of KNO₃. 8 to 12 wt. % of phenol formaldehyde resin, and 16 to 25 wt. % of DCDA (dicyandiamide).

### PRIOR ART DOCUMENTS

### Patent Document

Patent document 1: Japanese Laid-open Patent Publication No. 2009-72594
Patent document 2: Japanese Translation of PCT International Application No. 8-511958
Patent document 3: Japanese Laid-open Patent Publication No. 2011-62341
Patent document 4: Japanese Laid-open Patent Publication No. 2010-273925

### SUMMARY OF THE INVENTION

### Problem to be Solved by the Invention

In recent years, the applications of the aerosol fire extinguishing device as a vehicle and a vehicle engine room have been expanding due to its small size and light weight.

However, for example, in the aerosol fire extinguishing agent of Patent documents 1, 2 and 4, there is a possibility that the fire extinguishing agent might be damaged by heat or thermal shock.

Specifically, the resin used as a binder for tablets has poor thermal characteristics; therefore, it is fragile and not suitable as an aerosol fire extinguishing device in the environment that produces high temperature and large temperature difference such as an engine room for automobile. Further, since the changes of ambient temperature are directly transmitted as it is unsealed, the strong thermal shock is exerted. If it is exposed to high heat, there is also possibility of advancing deterioration.

Also, for example, the aerosol fire extinguishing device of the prior art 1 is the rigid structure; therefore, if it receives vibration or shock even if it is temporarily fixed, there is a possibility that the shock is directly applied to the fragile aerosol fire extinguishing agent causing damage to it.

The aerosol fire extinguishing device of Patent documents 1 and 3 is also unsealed; therefore, there is a possibility that foreign matter, moisture, and exhaust gas might enter in the aerosol fire extinguishing device causing condensation. As a result, the fire extinguishing agent might degrade immediately.

The aerosol fire extinguishing device of Patent document 3 has no fixed element of the internal components; therefore, there is also a possibility of displacement or dislodging due to vibration thereof.

The aerosol fire extinguishing agent of Patent document 4 uses the hard and brittle phenol formaldehyde resin as the binder of the drug; thus, there is a possibility that the fire extinguishing agent might be damaged by strong thermal shock, vibration, or impact of the automobile engine room.

As described above, the conventional aerosol fire extinguishing agent and the aerosol fire extinguishing device were not manufactured for the vehicle, but had environmental durability to an extent satisfying the general vehicle specifications.

Thus, for using the device in the environment exposed to high heating for long period, thermal shock, vibration, and the like such as the engine room, there were practical problems such as installation flexibility was low. i.e., the device must be fixed to a position where the temperature load is hard to increase.

With respect to this, for example, in the United States, the aerosol fire extinguishing device has been sold as vehicle fire extinguisher declaring clear US military MIL STD 810G.

In Japan, clear JIS/JASO standards are the minimum necessary requirements as automobile parts.

However, the company standards defined by the vehicle makers or the like become even more severe, and are no longer able to correspond in the conventional type aerosol fire extinguishing agent and aerosol fire extinguishing device.

The present invention has been made to solve such conventional problems, and an object of the present invention is to provide an aerosol fire extinguishing device having improved heat resistance and vibration resistance, and can be installed on a moving object such as a vehicle, and an aerosol fire extinguishing agent for use in the same.

Means for Solving the Invention

The aerosol fire extinguishing agent according to the present invention comprises an oxidizing agent, a reducing agent, and a reducing agent/binder, to which a fluororubber is added in an outer percentage of 0.5 wt. % to 5 wt. %.

The aerosol fire extinguishing agent according to the present invention also comprises 60 to 85 wt. % of potassium nitrate, 10 to 26.7 wt. % of dicyandiamide, and 5 to 13.3 wt. % of phenolic resin, to which a fluororubber is added in an outer percentage of 0.5 wt. % to 5 wt. %.

An aerosol fire extinguishing agent pellet according to the present invention is provided with a generally circular disk-shaped pellet with a press-molded aerosol fire extinguishing agent and having a fire extinguishing tool insertion hole in the center thereof, and a restrictor made of soft rubber applied onto the outer surface of the pellet.

In the aerosol fire extinguishing agent pellet according to the present invention, the restrictor is formed on the outer surface excluding the fire extinguishing tool insertion hole of the pellet.

In the aerosol fire extinguishing agent pellet according to the present invention, the restrictor is formed on the outer surface excluding the one end surface continuing to the fire extinguishing tool insertion hole of the pellet and the fire extinguishing tool insertion side of the fire extinguishing tool insertion hole.

In the aerosol fire extinguishing agent pellet according to the present invention, the coating thickness of the restrictor is 0.05 mm to 1 mm.

In the aerosol fire extinguishing agent pellet according to the present invention, the soft rubber is a silicone rubber.

The aerosol fire extinguishing device according to the present invention is provided with the aerosol fire extinguishing agent pellet according to the present invention.

The aerosol fire extinguishing device according to the present invention consists of an aerosol fire extinguishing agent pellet according to the present invention, a cushion material placed on one end face side of the aerosol fire extinguishing agent pellet, a bottom plate placed on one end face side of the cushion material and has a fire extinguishing tool insertion hole in the center, a fire extinguishing tool held airtightly via sealing agent in the fire extinguishing tool insertion hole of the bottom plate and has a fire extinguishing part in fire extinguishing tool insertion hole of the aerosol fire extinguishing agent pellet, a first spacer placed on the other end face side of the aerosol fire extinguishing agent pellet, a first wire netting placed on the other end face side of the first spacer, a first coolant layer placed on the other end face side of the first wire netting, a second wire netting placed on the other end face side of the first coolant layer, a second spacer placed on the other end face side of the second wire netting, a third wire netting placed on the other end face side of the second spacer, a second coolant layer placed on the other end face side of the third wire netting, a fourth wire netting placed on the other end face side of the second coolant layer, a third spacer placed on the other end face side of the fourth wire netting and has a step-like protruding part bulging to the outside of the other end face side, a third spacer placed on the other end face side of the fourth wire netting, an inner cylinder placed successively covering from the outside of the cushion material, outside of the aerosol fire extinguishing agent pellet, first spacer, first wire netting, first coolant layer, second wire netting, second spacer, third wire netting, second coolant layer, and fourth wire netting up to the outside of the protruding part of the third spacer, a cylindrical heat insulating material placed successively covering the outside of the inner cylinder and outside of the protruding part of the third spacer, a nozzle sheet placed on the other end face side of the third spacer and has plurality of nozzles, a top plate placed on the other end face side of the nozzle sheet, an outer cylinder placed in the outer portion of the bottom plate, cylindrical heat insulating material, nozzle sheet, and top plate, and has a caulking member caulking both ends on the bottom and top plates, a bottom plate seal part filled between the bottom plate and the caulking member, and a top plate seal part filled between the top plate and the caulking member.

In the aerosol fire extinguishing device according to the present invention, the outer cylinder is provided with one end having a bent portion caulked onto the bottom plate, and the other end caulked onto the top plate. The bottom plate equipped with a fire extinguishing tool, the cushion material, the aerosol fire extinguishing agent pellet the first spacer, the first wire netting, the first coolant layer, the second wire netting, the second spacer, the third wire netting, the second coolant layer, the fourth wire netting, the third spacer, the inner cylinder, the heat insulating material, the nozzle sheet, and the top plate are sequentially inserted into the outer cylinder from one end to the other end to form an internal structure. The other end of the outer cylinder is caulked onto the top plate by caulking fixture so as to prevent the generation of gaps between the internal structures. One end of the outer cylinder has bent portion caulked on to the bottom plate by caulking of the other end.

In the aerosol fire extinguishing device according to the present invention, the nozzle is formed in an approximately circular shape, and provided with a protrusion that protrudes to the inner diameter side.

### Effects of the Invention

The aerosol fire extinguishing agent according to the present invention can exhibit high fire suppression capability during combustion together with having durability to heat or thermal shock and physical shock by addition of fluororubber.

In the aerosol fire extinguishing agent pellet according to the present invention, by addition of fluororubber, the drug pellet can have elasticity thereby suppressing the occurrence of cracking or chipping of the drug pellet even when there is sudden change in the temperature and even after repeated thermal contraction by moderate elasticity.

In the aerosol fire extinguishing agent pellet according to the present invention, the restrictor having elasticity can follow the thermal shrinkage of the drug pellet; therefore, there is no risk of peeling of the restrictor.

Therefore, the drug can be stably burnt even in an environment such as a vehicle engine room repeatedly changing the temperature of high and low.

The aerosol fire extinguishing device according to the present invention holds the aerosol fire extinguishing agent pellet, the first coolant layer, and the second coolant layer by first spacer third spacer, therefore, there is no risk of internal structure displacement even if vibrations are applied to the aerosol fire extinguishing device.

The aerosol fire extinguishing device according to the present invention protects the aerosol fire extinguishing agent pellet by the cushion material; therefore, even if the vibrations are applied to the aerosol fire extinguishing device, the elasticity of the cushion material absorbs the impact thereby alleviating the impact applied to the aerosol fire extinguishing agent pellet.

Thus, the device can be installed for a long period of time even at a place where vibrations are applied such as the automobile engine room.

In the aerosol fire extinguishing device according to the present invention, the both ends of the outer cylinder are integrated by caulking, therefore, there is no risk of internal structure displacement even if vibrations are applied to the aerosol fire extinguishing device.

The aerosol fire extinguishing device according to the present invention is a watertight structure equipped with integrated both ends of the outer cylinder by caulking together with a seal portion in the caulking pan, and it covers the nozzle sheet with the top plate; therefore, the watertightness of the aerosol fire extinguishing device can be secured thereby imparting water and dustproof property.

Therefore, the aerosol fire extinguishing agent is protected from intrusion of foreign matters from the outside, dew condensation, and radiant heat of engine and the like until during operation. As a result, the device can withstand to long term use.

The aerosol fire extinguishing agent is protected from intrusion of foreign matters from the outside, dew condensation, and radiant heat of engine and the like until during operation; therefore, when the aerosol fire extinguishing agent burns in the fire, the internal pressure of the aerosol fire extinguishing device increases, the seal affixed to the nozzle can be certainly broken due to internal pressure releasing the extinguishing aerosol to the outside.

### BRIEF DESCRIPTION OF THE DRAWINGS

FIG. 1 is a longitudinal sectional view showing an aerosol fire extinguishing device according to one embodiment of the present invention.

FIG. 2 is a cross-sectional view showing section of the perspective view of aerosol fire extinguishing device according to one embodiment of the present invention in the longitudinal direction.

FIG. 3 is a bottom view of the aerosol fire extinguishing device according to one embodiment of the present invention.

FIG. 4 is a cross-sectional view showing an enlarged essential part of the aerosol fire extinguishing device according to one embodiment of the present invention.

FIG. 5 is a diagram showing a heat shock cycle test.

FIG. 6 is a diagram showing a temperature cycle test.

FIG. 7 is a cross-sectional view showing an example of applying the restrictor made of heat-resistant silicone to the one end face, outer peripheral surface, and other end face excluding the fire extinguishing tool insertion hole of the aerosol fire extinguishing agent pellet.

FIG. 8 is a cross-sectional view showing an example of applying the restrictor made of heat-resistant silicone to the outer peripheral surface and other end face excluding the one end face and the fire extinguishing tool insertion hole of the aerosol fire extinguishing agent pellet.

FIG. 9 is a schematic diagram showing that the size of the adhesive surface (inner diameter) of the restrictor does not change by the coating thickness of the restrictor during thermal expansion and contraction of the aerosol fire extinguishing agent pellet.

FIG. 10 is a schematic view showing an example of deformation of the restrictor made of heat-resistant silicone in response to thermal expansion and an example of peeling from the adhesive surface due to rigidity of the restrictor made of heat-resistant silicone

FIG. 11 is a schematic view showing a sink test to check the water resistance of the aerosol fire extinguishing device according to the present embodiment.

### MODE FOR CARRYING OUT THE INVENTION

Hereinafter, the embodiments of the present invention will be described with reference to the drawings.

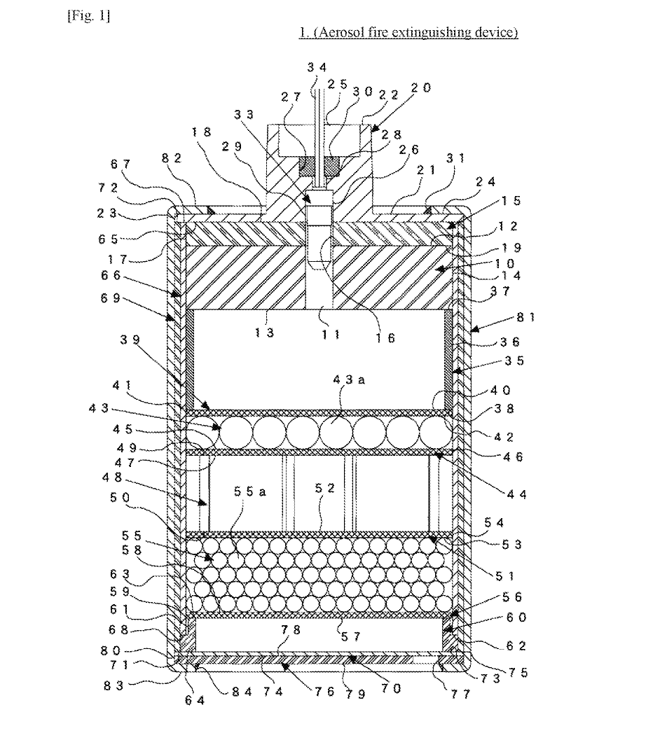

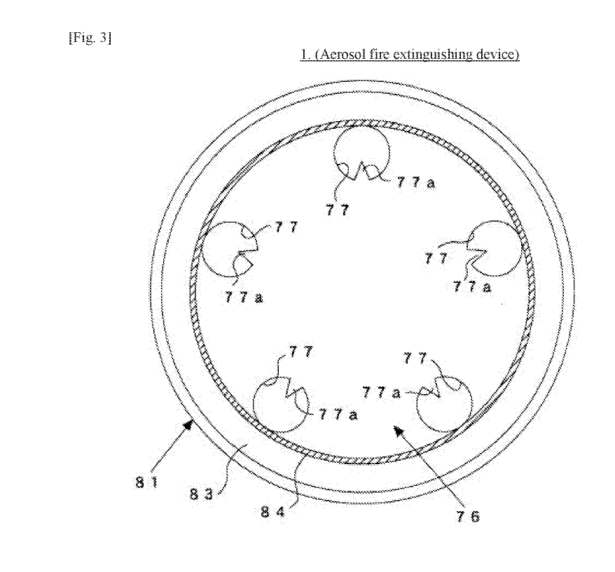

FIGS. 1 to 4 show the aerosol fire extinguishing device 1 according to one embodiment of the present invention.

The aerosol fire extinguishing device 1 according to the present embodiment is provided with a generally circular disk-shaped aerosol fire extinguishing agent pellet 10 and having a fire extinguishing tool insertion hole 11 in the center thereof.

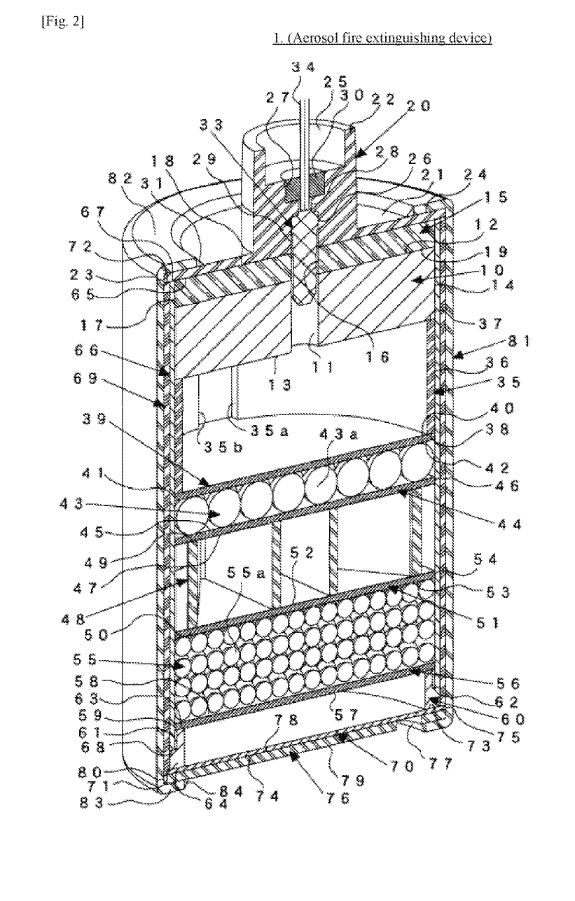

This aerosol fire extinguishing agent pellet 10, as described below, has durability to thermal or physical shock by the elastomeric resin dispersed and formulated in drug, and also has high fire suppression capability during drug combustion. The aerosol fire extinguishing agent pellet 10, as shown in FIG. 4, is also provided with a restrictor 90, described later, on one end face 12 and outer peripheral surface 14 excluding the fire extinguishing tool insertion hole 11. This restrictor 90 is ultrathin, i.e., 0.05 to 1 mm; therefore, it is omitted in FIGS. 1 and 2.

On the one end face 12 side of the aerosol fire extinguishing agent pellet 10, a generally circular disk-shaped cushion material 15 having fire extinguishing tool insertion hole in the center is placed. The cushion material 15 is composed of, for example, kraft paper laminates, glass wool, silicone rubber, or the like, and is used to prevent the impact being directly applied onto the aerosol fire extinguishing agent pellet 10.

The outer diameter of the cushion material 15 is almost the same as the outer diameter of the aerosol fire extinguishing agent pellet 10; therefore when the other end face 19 side of the cushion material 15 is mounted on one end face 12 side of the aerosol fire extinguishing agent pellet 10, as shown in the drawing, a continuous surface is formed without causing any level difference between the outer peripheral surface 14 of the aerosol fire extinguishing agent pellet 10 and the outer peripheral surface 17 of the cushion material 15.

The bottom plate 20 is placed on one end face 18 side of the cushion material 15. The bottom plate 20 is formed in an approximately T-shaped cross section, and has the fire extinguishing tool insertion hole 26 in the center. The bottom plate 20 is composed of, for example, metal materials such as SUS, aluminum alloy, and is used to hold the fire extinguishing tool 33 described later.

The bottom plate 20 is provided with a generally circular disk-shaped plate portion 21 and a generally cylindrical-shaped fire extinguishing tool mounting portion erected integrally in the center of the plate portion 21.

The generally circular disk-shaped plate portion 21 has an outer diameter greater than the outer diameter of the aerosol fire extinguishing agent pellet 10 and the cushion material 15. The outer peripheral surface 23 of the plate portion 21 that forms the outer peripheral surface of the bottom plate 20 abuts on the inner surface of the outer cylinder 81 described later. A part of the surface portion 24 of the plate portion 21 continuous to the outer peripheral surface 23 of the plate portion 21 is also covered by the end portion 82 of the outer cylinder 81 to be caulked in a circular shape. The sealing agent is filled between the periphery of the end portion 82 of the outer cylinder 81 that is caulked in a circular shape and the surface portion 24 of the plate portion 21, to form an airtight seal portion 31. The sealing agent is composed of, for example, epoxy resin, silicon resin, rubber, fluorine resin, and the like.

The generally cylindrical-shaped fire extinguishing tool mounting portion 22 is provided with a recess 25 that opens on the upper side, and a fire extinguishing tool insertion hole 26 passes from the center bottom surface of the recess 25 towards the bottom surface of the plate portion 21.

The fire extinguishing tool insertion hole 26 is provided with a recess 27 for forming an airtight seal portion 30 with the sealing agent for holding a leg line 34 of the inserted fire extinguishing tool 33. The sealing agent is composed of, for example, epoxy resin, silicon resin, rubber, fluorine resin, and the like. The small holes 28 for inserting the leg line 34 of the fire extinguishing tool 33 are made in the recess 27. The fire extinguishing tool assembly holes 29 for assembling the fire extinguishing tool 33 are continuous to these small holes 28. The fire extinguishing tool assembly holes 29 open at the bottom face side of the plate portion 21.

The fire extinguishing tool 33 is composed of, for example, potassium nitrate-base fire extinguishing agent, priming powder such as boron/copper oxide mixed powder, and an igniter such as fuse head for carrying out ignition of the aerosol fire extinguishing agent pellet 10. The fire extinguishing tool 33 is held by being screwed into the fire extinguishing tool assembling hole 29 so that the tip from the bottom side of the plate portion 21 protrudes, passes through the fire extinguishing tool insertion hole 16 of the cushion material 15, and inserted into the aerosol fire extinguishing agent pellet 10 of the fire extinguishing tool insertion hole 11.

The first spacer 35 is placed on the other end face 13 side of the aerosol fire extinguishing agent pellet 10. The first spacer 35 is an approximately C-shaped ring member with spaces 35a and 35b at both ends. It is composed of, for example, metal materials such as SUS, aluminum alloy, steel, and the like. The first spacer 35 is used to maintain the space between the aerosol fire extinguishing agent pellet 10 and the first coolant layer 43 described later. One end surface 37 side of the first spacer 35 exhibits the function of support column to hold the aerosol fire extinguishing agent pellet 10 by abutting to the other end face 13 of the aerosol fire extinguishing agent pellet 10. It forms a continuous surface without causing a level difference between the outer peripheral surface 36 of the first spacer 35 and the outer peripheral surface 14 of the aerosol fire extinguishing agent pellet 10.

The first coolant layer 43 held by the first wire netting 39 and the second wire netting 44 is placed on the other end face 38 side of the first spacer 35.

The first wire netting 39 is composed of, for example, metal materials such as SUS, steel.

One end surface 40 side of the first wire netting 39 is brought into contact with the other end face 38 side of the first spacer 35. The outer peripheral surface 41 of the first wire netting 39 is almost equal to the outer peripheral surface 36 of the first spacer 35.

The first coolant layer 43 is place on the other end face 42 side of the first wire netting 39. In the first coolant layer 43, a plurality of coolants 43a molded as sphere or tablet composed of, for example, alumina, silica, zeolite, kaolin. SUS, and the like, is arranged in a row. The first coolant layer 43 exhibits the function of exchanging heat with combustion gas to reduce the jetting aerosol temperature. Note that the coolant 43a may support the catalyst by such as alumina, silica, zeolite, kaolin, SUS, and the like.

The second wire netting 44 is composed of, for example, metal materials such as SUS, steel. One end face 45 side of the second wire netting 44 is brought into contact with the first coolant layer 43. The outer peripheral surface 46 of the second wire netting 44 is almost equal to the outer peripheral surface 41 of the first wire netting 39.

The first wire netting 39 and the second wire netting 44 are used to hold the first coolant layer 43.

The second spacer 48 is placed on the other end face 47 side of the second wire netting 44. The second spacer 48 is formed such that the band plate made up of metal materials such as SUS, aluminum alloy, copper, and the like is bent in the wave form to form outer shape that approximates with second wire netting 44. The second spacer 48 holds the second wire netting 44 at one end face 49 side of the multiple bent portions.

The second coolant layer 55 held by the third wire netting 51 and the fourth wire netting 56 is placed on the other end face 50 side of the second spacer 48.

The third wire netting 51 is composed of, for example, metal materials such as SUS, steel, and the like.

One end face 52 side of the third wire netting 51 is brought into contact with the other end face 50 of the second spacer 48. The outer peripheral surface 54 of the third wire netting 51 is almost equal to the outer peripheral surface 41 of the first wire netting 39 and the outer peripheral surface 46 of the second wire netting 44. The second coolant layer 55 is placed on the other end face 53 side of the third wire netting 51.

In the second coolant layer 55, a plurality of coolants 55a molded as sphere or tablet composed of, for example, alumina, silica, zeolite, kaolin. SUS, and the like, is arranged in a row. The second coolant layer 55 exhibits the function of exchanging heat with combustion gas to reduce the jetting aerosol temperature. Note that the coolant 55a may support the catalyst by such as alumina, silica, zeolite, kaolin, SUS, and the like.

The coolant 55a of the second coolant layer 55 is formed as a sphere or a tablet of diameter smaller than the coolant 43a of the first coolant layer 43.

The fourth wire netting 56 is composed of, for example, metal materials such as SUS, steel, and the like.

One end face 58 side of the fourth wire netting 56 is brought into contact with the second coolant layer 55. The outer peripheral surface 59 of the fourth wire netting 56 is almost equal to the outer peripheral surface 41 of the first wire netting 39, the outer peripheral surface 46 of the second wire netting 44, and the outer peripheral surface 54 of the third wire netting 51.

The third spacer 60 is placed on the other end face 57 side of the fourth wire netting 56. The third spacer 60 is formed in a cylindrical body made up of metal materials such as SUS, aluminum alloy, and the like.

On the outer surface of the third spacer 60, a notch portion 61 is formed for placing the other end face 68 side of the inner cylinder 66 arranged on the outer surface 59 side of the cushion material 15, aerosol fire extinguishing agent pellet 10, first spacer 35, first wire netting 39, first coolant layer 43, second wire netting 44, second spacer 48, third wire netting 51, second coolant layer 55, and fourth wire netting 56. In this notch portion 61, the protruding part 62 protruding as much as equal to the wall thickness of the inner cylinder 66 is formed for holding the other end face 68 side of the inner cylinder 66. One end face 67 of the inner cylinder 66 is brought into contact with the other end face 65 of the plate portion 21 of the bottom plate 20.

The inner cylinder 66 is composed of, for example, SUS, steel, and the like, and is used for holding the heat insulating material 69 and each component.

The cylindrical heat insulating material 69 is placed on the outer portion of the inner cylinder 66 and the outer portion of the protruding part 62 of third spacer 60. The heat insulating material 69 is composed of, for example, glass wool, rock wool, ceramic paper, and the like, and alleviates the thermal changes at the time of heat and fire extinguishing agent spraying from outside. One end face 72 of the heat insulating material 69 is brought into contact with one end portion 67 of the inner cylinder 66 together with other end face 65 of the plate portion 21.

The nozzle sheet 70 is placed on the other end face 64 side of the third spacer 60 and other end face side 71 of the heat insulating material 69. The nozzle sheet 70 is composed of, for example, aluminum deposited polyester tape and the like. One end face 73 side of the nozzle sheet 70 is brought into contact with the other end face 64 side of the third spacer 60 and the other end face side 71 of the heat insulating material 69. The outer peripheral surface 75 of the nozzle sheet 70 is brought into contact with the inner peripheral surface of the outer cylinder 81.

The top plate 76 comprising a plurality of nozzles 77 is placed on the other end face 74 side of the nozzle sheet 70. Each nozzle is provided with a protrusion 77a having an angle of 45 degrees from the circle periphery toward the center. This protrusion 77a can help in the breaking of the nozzle seal 70 during operation of the aerosol fire extinguishing device 1. The top plate 76 is composed of, for example, metal materials such as SUS, aluminum alloy, steel, and the like. One end face 78 side of the top plate 76 is superimposed on the other end face 74 side of the nozzle sheet 70.

The outer peripheral surface 80 of the nozzle sheet 70 is brought into contact with the inner peripheral surface of the outer cylinder 81. A part of the outer peripheral surface 79 of the nozzle sheet 70 is covered by the end portion 83 of the outer cylinder 81 to be caulked in a circular shape. The sealing agent is filled between the periphery of the end portion 83 of the outer cylinder 81 that is caulked in a circular shape and the top plate 76, to form a highly airtight seal portion 84. The sealing agent is composed of, for example, epoxy resin, silicon resin, rubber, fluorine resin, and the like.

Hereinafter, the assembly method of the aerosol fire extinguishing device 1 according to the present embodiment will be explained.

The outer cylinder 81 is firstly inserted in the caulking fixture to caulk the end portion 82 almost at a right angle.

Next, each component is inserted into the outer cylinder 81. This work is in the state of reversed top and bottom of the aerosol fire extinguishing device 1 according to the present embodiment as shown in FIG. 1.

The bottom plate 20 fitted with the fire extinguishing tool 33 is firstly inserted into the outer cylinder 81, and the inner cylinder 66 and the heat insulating material 69 are subsequently inserted until they abut into the plate portion 21 of the bottom plate 20.

Next, the cushion material 15, aerosol fire extinguishing agent pellet 10, first spacer 35, first wire netting 39, first coolant layer 43, second wire netting 44, second spacer 48, third wire netting 51, second coolant layer 55, and fourth wire netting 56 are sequentially inserted into the inner cylinder 66.

The outer surface 61 of the third spacer 60 is assembled at the other end face 68 of the inner cylinder 66 together with assembling the outer surface of the third spacer 60 at the inner surface of the heat insulating material 69.

The nozzle sheet 70 and the top plate 76 are sequentially inserted into the other end face of the heat insulating material 69 and the other end face 64 of the third spacer 60. The nozzle sheet 70 and the top plate 76 should be attached beforehand.

Then, as described above, the outer cylinder 81 with inserted each component is again inserted in the caulking fixture to caulk the outer peripheral edge portion 83 of the outer cylinder 81 of the top plate 76 side which becomes an open end by press at a press pressure of 8 to 10 tons.

The sealing agent is then filled into the caulking member 83 of the top plate 76 and the contact portion 82 of the bottom plate 20 and the outer cylinder 81, and the sealing agent 30 is filled in the gaps between the leg lines 34 of the fire extinguishing tool 33 and the bottom plate 20.

By the above, the assembly of the aerosol fire extinguishing device 1 according to the present embodiment is completed.

Hereinafter, the action of the aerosol fire extinguishing device 1 according to the present embodiment will be explained.

Firstly, the electric current is passed through the leg lines 34 from the outside to the fire extinguishing tool 33 to ignite the aerosol fire extinguishing agent pellet 10.

Then, the aerosol fire extinguishing agent pellet 10 is burned to produce extinguishing aerosol.

The produce extinguishing aerosol is then jetted into the first spacer 35, which flows into the first coolant layer 43. As it passes through the first coolant layer 43, the heat is exchanged to lower the temperature of the extinguishing aerosol.

The extinguishing aerosol which has passed through the first coolant layer 43 is then jetted into the second spacer 48.

The extinguishing aerosol jetted into the second spacer 48 flows into the second coolant layer 55. As it passes through the second coolant layer 55, the heat is exchanged to further lower the temperature of the extinguishing aerosol.

The extinguishing aerosol which has passed through the second coolant layer 55 is then jetted into the third spacer 60.

The nozzle sheet 70 is then broken by the increased internal pressure by extinguishing aerosol jetting into the third spacer 60, and the extinguishing aerosol is released to the outside of the aerosol fire extinguishing device 1 from the nozzle 77 that is opened to the top plate 76.

Hereinafter, the aerosol fire extinguishing agent pellet 10 will be explained.

In the present embodiment, the aerosol fire extinguishing agent pellet 10 is provided with the fire extinguishing tool insertion hole 11 in the center and press molded from the aerosol fire extinguishing agent comprising an oxidizing agent, a reducing agent, a reducing agent/binder, and a fluororubber.

As oxidizing agents, alkali metal salts and alkaline earth metal salts that act as oxidizing agent can be applied. Examples include potassium nitrate, potassium chlorate, potassium perchlorate, potassium ferrocyanide, potassium salts such as potassium dichromate, cesium nitrate, cesium salts such as cesium perchlorate, sodium nitrate, sodium perchlorate, and sodium salts of sodium oxalate, and the like.

The reducing agent can be applied as far as it is a substance that can be oxidized. Examples include dicyandiamide, carbon compounds such as charcoal, cellulose, Teflon powder (a registered trademark), sulfur, saccharides such as sucrose, cellulose acetate, and the like.

Examples of binder/reducing agent include phenolic resins, melamine resins, unsaturated polyester resins, epoxy resins, various polymers, gums, lacquer, gelatin, guar gum, agarose, camphor, and paraffin waxes.

In the present embodiment, potassium nitrate, dicyandiamide, and phenolic resin are selected as oxidizing agent, reducing agent, and binder/reducing agent, respectively.

Hereinafter, the usable range of each agent will be explained.

The potassium radicals produced due to burning of the aerosol fire extinguishing agent contribute to fire extinguishing.

Even if only the mixed pellet of potassium nitrate, dicyandiamide, and phenolic resin is burned, it may be said to have fire extinguishing ability as it produces potassium radicals.

With the given range of agents of compositions 1 to 10 as shown in Table 1, it was confirmed that whether the fire extinguishing agent pellet is molded in the same weight and whether the fire extinguishing ability exists against the same scale of fire.

| | |
|---|---|
| Simulated fire fuel: | Heptane (Class I petroleum, 4 kinds) |
| Simulated fire area: | 0.06 m² |
| Simulated fire space: | 1 m³ |
| Fire extinguishing agent | 30 g/m³ |
| concentration: | |

Results are shown in Table 1

TABLE 1

| | Composition wt. % | | | | |
|---|---|---|---|---|---|
| | Potassium | | | Fire Extinguishing | |
| | nitrate | Dicyandiamide | Phenolic resin | Possibility | Remarks |
| Composition 1 | 55 | 40 | 5 | No | Agent combustion |
| | | | | | interrupted |
| Composition 2 | 55 | 35 | 10 | No | Agent ignition misfired |
| Composition 3 | 60 | 26.7 | 13.3 | Yes | |
| Composition 4 | 65 | 26 | 9 | Yes | |
| Composition 5 | 67 | 25 | 8 | Yes | |
| Composition 6 | 72 | 16 | 12 | Yes | |
| Composition 7 | 75 | 16.5 | 8.5 | Yes | |
| Composition 8 | 80 | 13.3 | 6.7 | Yes | |
| Composition 9 | 85 | 10 | 5 | Yes | |
| Composition 10 | 990 | 7 | 3 | No | Agent ignition misfired |

Compositions 3 to 9 were confirmed to function as effective aerosol fire extinguishing agent.

The result showed the following percentage of the agents.

| | |
|---|---|
| Potassium nitrate: | 60 wt. % to 85 wt. % |
| Dicyandiamide: | 10 wt. % to 26.7 wt. % |
| Phenolic resin: | 5 wt. % to 13.3 wt. % |

The pellet of 65 mm diameter was formed with the aerosol fire extinguishing agent of the composition 8 (potassium nitrate 80 wt. %, dicyandiamide 13.3 wt. %, and phenolic resin 6.7 wt. %). The resulting shape is provided with a fire extinguishing agent insertion tool 11 as similar to that of the aerosol fire extinguishing agent pellet 10 shown in FIG. 1.

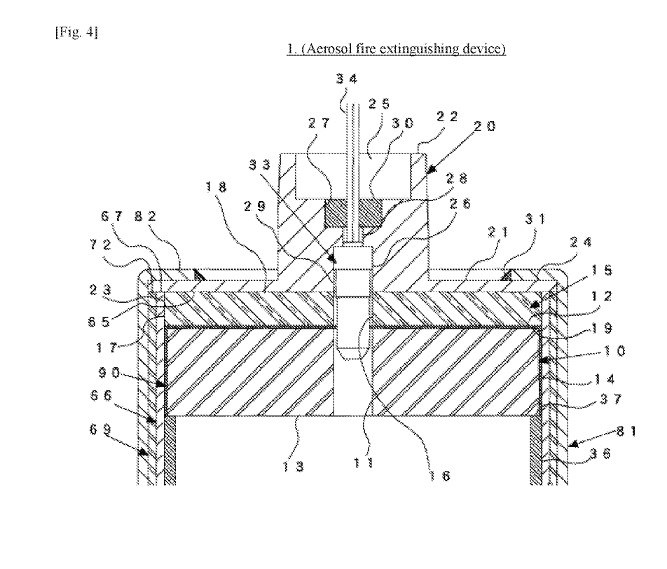

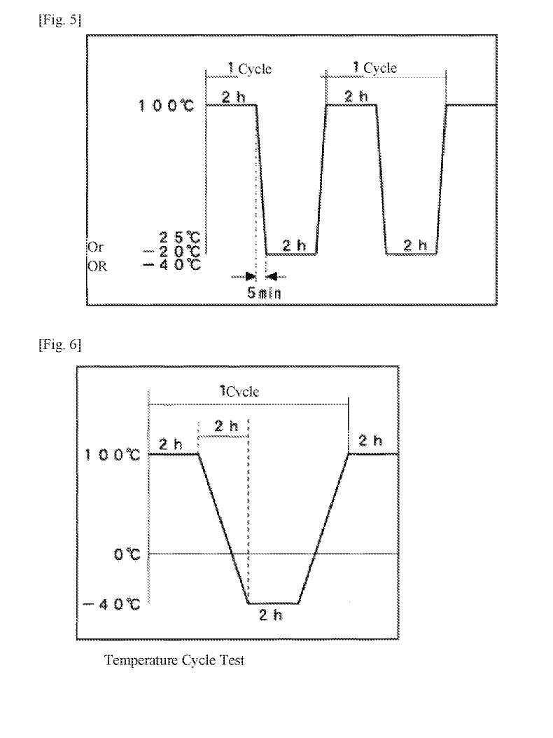

The resulting aerosol fire extinguishing agent pellet was subjected to the heat shock cycle test and the temperature cycle test as shown in FIG. 5 and FIG. 6, respectively.

Any of the test results showed that cracks were generated in the aerosol fire extinguishing agent pellet.

Therefore, in order to improve heat and vibration resistance of the aerosol fire extinguishing agent pellet, various materials were added, thus, the addition of fluororubber to the composition 8 in an outer percentage of 0.5 to 5 wt. % was found to be optimal. The results are shown in Table 2.

As shown in Table 2, when fluororubber exceeds 5 wt. % and becomes 6 wt. %, it can withstand in the temperature cycle and heat shock from 25° C.; however, it does not burn (no firing); therefore, it was confirmed that this is not preferable.

TABLE 2
Evaluation Test by Pellet Unit

| | | | | Heat Shock | | | Temperature Cycle |
|---|---|---|---|---|---|---|---|
| | | | | | | −40° C. (2 h) [symbol] | −40° C. (2 h) [symbol] (2 h) [symbol] |
| Composition (wt. %) | | | | 25° C. (2 h) [symbol] 100° C. (2 h) | −20° C. (2 h) [symbol] 100° C. (2 h) | 100° C. (2 h) | 100° C. (2 h) |
| Potassium | Dicyandi | Phenolic | Fluororu | (32 Cycles) | (32 Cycles) | (32 Cycles) | (32 Cycles) |
| 80 | 13.3 | 6.7 | 0 | X | X | X | X |
| 80 | 13.3 | 6.7 | 0.5 | ◯ | X | X | ◯ |
| 80 | 13.3 | 6.7 | 1 | ◯ | X | X | ◯ |
| 80 | 13.3 | 6.7 | 1.5 | ◯ | X | X | ◯ |
| 80 | 13.3 | 6.7 | 2 | ◯ | X | X | ◯ |
| 80 | 13.3 | 6.7 | 5 | ◯ | X | X | ◯ |

| | | | | |
|---|---|---|---|---|
| 80 | 13.3 | 6.7 | 6 | Can withstand in the temperature cycle and heat shock from 25° C.; however, it does |
| | | | | not burn (no firing); |

Dismantling evaluation (one each composition): No cracks in the dismantled pellet. 5% or more of weight do not become powder. ◯: No abnormality X Cracks with powdering

Hereinafter, the manufacturing method of the aerosol fire extinguishing agent will be explained.

Potassium nitrate 78.8 wt. % and dicyandiamide 13.1 wt. % in a powdered state are mixed for 3 minutes using an agitator. The phenolic resin was weighed so as to become 6.6 wt. % and dissolved in acetone. At this time, the dissolution was carried out in 5 ml acetone per 1 g of phenolic resin.

The phenolic resin solution was poured into the prepared mixture of potassium nitrate and dicyandiamide and mixed for 10 minutes.

Next the fluororubber was weighed so as to become 1.5 wt. % and dissolved in acetone. At this time, the dissolution was carried out in 10 ml acetone per 1 g of fluororubber.

This solution was poured into the prepared wet mixture of potassium nitrate, dicyandiamide, and phenolic and mixed for 10 minutes. This was considered as the fire extinguishing agent wet mixture.

The fire extinguishing agent wet mixture was air dried up to the viscosity where extrusion granulation becomes easy, and the extrusion granulation was performed using a granulation screen having aperture of 1 mm. The acetone was completely dried at 40° C. from the granulated material for weighing 100 g granulated material at a time.

The measured granulated material was placed in the mold to perform press molding such that the pressure per unit area of the aerosol fire extinguishing agent pellet molding punch becomes 1530 kg/cm² to 1835 kg/cm². The finished aerosol fire extinguishing agent pellet has diameter 65 mm, height about 17 mm, fire extinguishing tool insertion hole diameter 7.5 mm, and specific gravity about 1.7 to 1.8.

Hereinafter, addition of fluororubber will be explained.

The composition mentioned in the prior art as the pharmaceutical composition of the aerosol fire extinguishing device contains substances that act as binders such as resins in the majority

The binder is specifically required for molding the aerosol fire extinguishing agent, a component for “bridging” of powder composition.

The component having no binder will be molded by pressing the powder and the like. Press molding may be performed even if binder is included.

Thus, the aerosol fire extinguishing agent, based on the principle thereof, is composed mainly of inorganic oxidizing agents such as potassium nitrate, potassium perchlorate, potassium dichromate.

These are mixed with the binder, and simply by squeeze molding, they become hard and brittle without elasticity.

The main component of the aerosol fire extinguishing agent based on the composition ratio is the oxidizing agent, therefore, it is difficult improve hard and brittle physical properties and to extremely increase the quantity of the conventional binder.

Fluororubber does not chemically change the physical properties by reacting with the components of the aerosol fire extinguishing agent, and it is uniformly dispersed in the composition even when present in very small quantity; thus, it can act as the buffer material between powder particles thereby imparting elasticity.

Therefore, regardless of the composition, the effect of fluororubber addition can be obtained in case of powder molding.

Next, in the same composition 8, the aerosol fire extinguishing agent pellet to which the fluororubber was added in an outer percentage of 0.5 to 5 wt. % was used instead of the aerosol fire extinguishing agent pellet 10 of the aerosol fire extinguishing device 1 as shown in FIGS. 1 to 4. The results are shown in Table 3.

As shown in Table 3, in the composition 8, the aerosol fire extinguishing agent pellet to which the fluororubber was added in an outer percentage of 0.5 to 5 wt. % was confirmed to withstand the heat shock test, temperature cycle test, and vibration test.

TABLE 3
Evaluation Test in a State where Pellet is incorporated in Housing

| | | | | Heat Shock | | | Temperature | |
|---|---|---|---|---|---|---|---|---|
| | | | | 25° C. (2 h) [symbol] | −20° C. (2 h) [symbol] | −40° C. (2 h) [symbol] | −40° C. (2 h) [symbol] (2 h) [symbol] | Vibration |
| Composition (wt. %) | | | | 100° C. (2 h) | 180° C. (2 h) | 100° C. (2 h) | 100° C. (2 h) | JIS1601 |
| Potassium | Dicyandi | Phenolic | Fluororu | (32 Cycles) | (32 Cycles) | (32 Cycles) | (32 Cycles) | MIL-STD-810 |
| 80 | 13.3 | 6.7 | 0 | X | X | X | X | X |
| 80 | 13.3 | 6.7 | 0.5 | ◯ | ◯ | ◯ | ◯ | ◯ |
| 80 | 13.3 | 6.7 | 1 | ◯ | ◯ | ◯ | ◯ | ◯ |
| 80 | 13.3 | 6.7 | 1.5 | ◯ | ◯ | ◯ | ◯ | ◯ |
| 80 | 13.3 | 6.7 | 2 | ◯ | ◯ | ◯ | ◯ | ◯ |
| 80 | 13.3 | 6.7 | 5 | ◯ | ◯ | ◯ | ◯ | ◯ |

| | | | | |
|---|---|---|---|---|
| 80 | 13.3 | 6.7 | 6 | No burning (no firing) |

Dismantling evaluation (one each composition): No cracks in the dismantled pellet. 5% or more of weight do not become powder. ◯: No abnormality X Cracks with powdering
Combustion Evaluation (one each composition): Combustion for a predetermined period of time (9 to 12 seconds), intermittent combustion, and no occurrence of rapid combustion after firing were confirmed.
Items which are “◯” in both Dismantling and Combustion Evaluation are evaluated as “◯” in above Table. Items which are “X” in any of Dismantling and Combustion Evaluation are evaluated as “X”.

Here, vibration test will be explained.

In Table, JIS 1601 is Type-3 (mainly track system) Class-D (conditions of relatively large vibrations when mounted on engine and when mounted under spring for suspension system) Stage-110 vibration testing. Test conditions in the absence of resonance are frequency of vibration 67 or 167 Hz and vibration acceleration 110 m/S². Under these conditions, vibrations are continuously applied to the same sample in Z (up and down) and Y (front and back) directions for 4, 2, and 2 hours respectively.

In Table, MIL-STD-810 is a MIL-STD-810G Method 514.6 table 514.6C-IV. It is a category 4 wheeled vehicle complex vibration. In 3-axis directions, the vibration is applied for 2 hours per axis direction 5 to 500 Hz with the acceleration average 1.5 to 2.24 G.

Next, in the same composition 8, the aerosol fire extinguishing agent pellet to which the fluororubber was added in an outer percentage of 0.5 to 5 wt. % was used instead of the aerosol fire extinguishing agent pellet 10 of the aerosol fire extinguishing device 1 as shown in FIGS. 1 to 4 to test the changes in the vibration resistance (each n=2). The changes in the vibration resistance are shown in Table 4.

Here, the combustibility and the residual rate (vibration test) were checked in the built-in state in the outer cylinder 81.

For the combustibility in the built-in state in the outer cylinder 81, combustion for a predetermined period of time (9 to 12 seconds), intermittent combustion, and no occurrence of rapid combustion after firing were confirmed.

For the residual rate (vibration test), dismantling was performed after vibration test, the pellet was removed, and the weight was measured. The weight was measured excluding what have become broken pieces or powder due to vibration. The change in the weight is recorded as the residual rate when assuming the original weight as 100%.

TABLE 4

| Evaluation | Fluororubber Compounding Ratio [%] | | | | | |
|---|---|---|---|---|---|---|
| Item | 0 | 0.5 | 1.5 | 2 | 5 | 6 |
| Dismantling | Pellet | Pellet ends | Almost no | Almost no | Almost no | Almost no |
| test | breaking | are slightly | damage | damage | damage | damage |
| | caused by | powdered | | | | |
| | vibration | | | | | |
| Residual rate | 65% | 98% | 99% or | 99% or | 99% or | 99% or |
| | | | more | more | more | more |
| Jet test | Abnormal | Normal | Normal | Normal | Normal | No |
| | combustion | combustion | combustion | combustion | combustion | combustion |
| | | | | | | (no firing) |

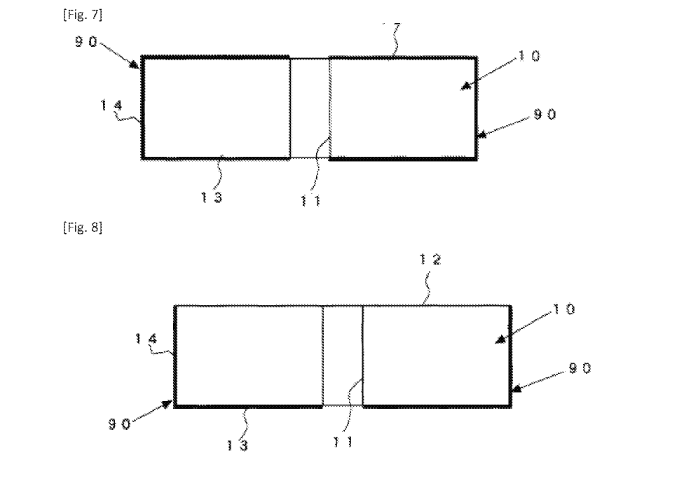

Next, in the present embodiment, the restrictor 90 made of heat-resistant silicone was used that can follow the thermal shrinkage of the aerosol fire extinguishing agent pellet 10 as shown in FIG. 4; however, the present invention is not limited thereto, and the case of applying the restrictor 90 made of heat-resistant silicone to the one end face 12, outer peripheral surface 14, and other end face 13 excluding the fire extinguishing tool insertion hole 11 of the aerosol fire extinguishing agent pellet 10 as shown in FIG. 7, or the case of applying the restrictor 90 made of heat-resistant silicone to the outer peripheral surface 14 and one end face 12 excluding the other end face 13 and the fire extinguishing tool insertion hole 11 of the aerosol fire extinguishing agent pellet as shown in FIG. 8, can also be used.

Evaluation method was based on the heat shock cycle test as shown in FIG. 5 and the temperature cycle test as shown in FIG. 6.

As shown in FIGS. 4, 7, and 8, the restrictor 90 made of heat-resistant silicone was applied to the aerosol fire extinguishing agent pellet 1. After application of heat shock and temperature cycles, the boundary between the restrictor 90 and the aerosol fire extinguishing agent pellet 10 was observed. The result is shown in Table 5.

As the coating agent, the conventionally used aqueous ceramics and silicone rain were used.

TABLE 5

| | Coating | Heat Shock | | Temperature Cycle |
|---|---|---|---|---|
| Coating | Thickness | 25° C. (2 h) [symbol] 100° C. (2 h) | −40° C. (2 h) [symbol] 100° C. (2 h | −40° C. (2 h) [symbol] 100° C. (2 h) |
| Agent | mm | (32 cycles) | (32 cycles) | (32 cycles) |
| Aqueous | 0.5 | X | X | X |
| ceramics | | | | |
| Silicone resin | 0.02 | X | X | X |
| | 0.05 | ◯ | ◯ () | ◯ |
| | 0.1 | ◯ | ◯ () | ◯ |
| | 0.5 | ◯ | ◯ () | ◯ |

( Pellet is broken, but no peeling from the pellet of silicone resin)

Hereinafter, the thickness of the restrictor 90 will be further explained.

The coating thickness is 0.05 mm or more, and the maximum value of the coating thickness depends on the inner diameter of the inner cylinder 66. The thickness should be made to an extent by excess coating such that the restrictor fits into the inner cylinder 66.

If the coating thickness is less than 0.05 mm, the restrictor might peeled off during combustion transferring the flames.

If the coating is extremely thick, the restrictor 90 might spread out and peeled from the aerosol fire extinguishing agent pellet 10 under high temperature due to difference in thermal expansion coefficient of materials of the restrictor 90 and the aerosol fire extinguishing agent pellet 10.

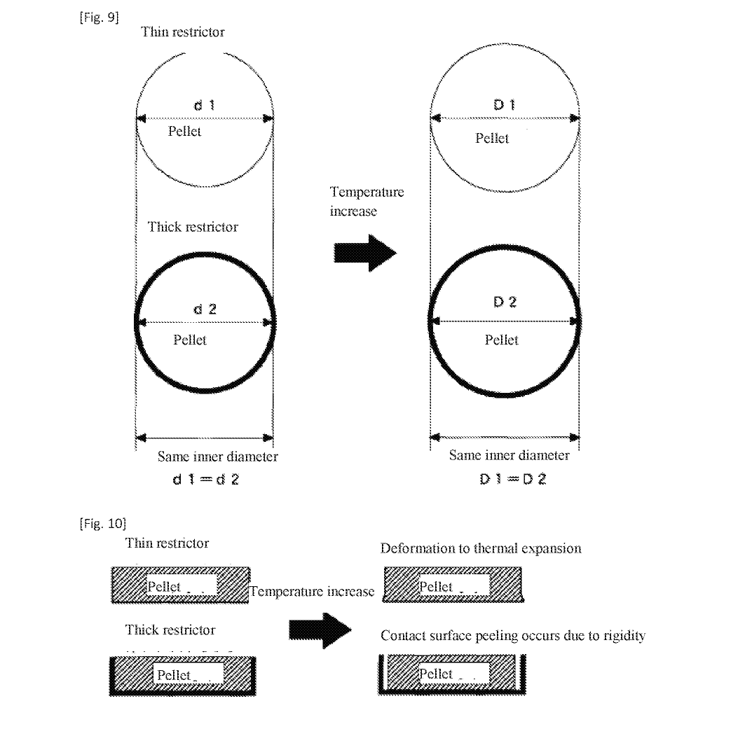

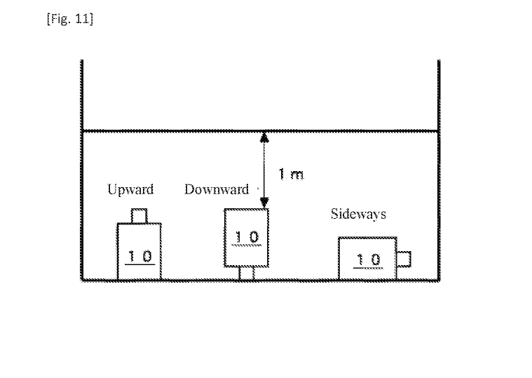

For example, as shown in FIG. 9, the size of the adhesive surface (inner diameter) of the restrictor 90 does not change by the coating thickness of the restrictor during thermal expansion and contraction. However, the aerosol fire extinguishing agent pellet 10 is an aggregate of powder, therefore, for example, as shown in FIG. 10, the surface peeling of the bonded restrictor 90 is likely to be occur.

Here, if the thickness of the restrictor 90 increases, it is believed that the stress applied to the adhesive surface also increases; therefore, it is believed that the peeling occurs from certain degree of coating thickness.

While the linear expansion coefficient of the aerosol fire extinguishing agent pellet is in the order of approximately 10 to 100×10⁻⁶, the linear expansion coefficient of the of restrictor 90 is about 2 to 4×10⁻⁴, having big difference; therefore, when exposed to temperature changes in a wide range from −40° C. to 100° C. there will be a gap if both are not bonded together.

With coating thickness of about 0.5 mm, the bonded restrictor 90 can be extended thereby preventing the gaps.

If the coating thickness increases, the rigidity of the restrictor 90 increases; therefore, in case of temperature changes, the force to peel off from the adhesive surface works strongly.

Therefore, the coating thickness of the restrictor 90 is experimentally decided as follows.

The restrictor 90 was applied to the aerosol fire extinguishing agent pellet 10 by changing the thickness and was subjected to following temperature cycle and heat shock cycle.

Here, the aerosol fire extinguishing agent pellet 10 is directly inserted into thermostat chamber without incorporating into the inner cylinder 66 and the like.

After applying heat shock and temperature cycles, the peeling of the boundary surface between the restrictor 90 and the aerosol fire extinguishing agent pellet 10 is observed.

TABLE 6

| | | | | Temperature |
|---|---|---|---|---|
| | | Heat Shock | | Cycle |
| | Coating | 25° C. (2 h) [symbol] 100° C. | −40° C. (2 h) [symbol] 100° C. | −40° C. (2 h) [symbol] (2 h) [symbol] |
| | Thickness | (2 h) | (2 h) | 100° C. (2 h) |
| Coating Agent | mm | (32 cycles) | (32 cycles) | (32 cycles) |
| Silicone resin | 0.02 | X | X | X |
| | 0.05 | ◯ | ◯ () | ◯ |
| | 0.1 | ◯ | ◯ () | ◯ |
| | 0.5 | ◯ | ◯ () | ◯ |
| | 1 | ◯ | ◯ () | ◯ |
| | 2 | X | X | X |

( Pellet is broken, but no peeling from the pellet of silicone resin)

In Table, O indicates no change, x indicates defects such as peeling.

Test results are as follows.

For the coating thickness of 0.02 mm, no peeling was noted from the adhesive surface of the aerosol fire extinguishing agent pellet 10; however, splitting of the restrictor 90 was noted due to thermal expansion.

For the coating thickness of 2 mm or more, the adhesive surface of the aerosol fire extinguishing agent pellet 10 and the restrictor 90 cannot correspond to the thermal expansion; thus, peels off.

Therefore, the coating thickness of the restrictor 90 has been decided as 0.05 mm to 1 mm.

Hereinafter, the vibration resistance will be explained.

It is understood that the aerosol fire extinguishing device 1 has the cushion material 15; therefore, vibration and shock resistance is improved. If there is no cushion material 15, the aerosol fire extinguishing agent pellet 10 will be damaged. Note that lack of caulking will deviate the internal components of the aerosol fire extinguishing device 1, and the function as the aerosol fire extinguishing device 1 will be lost.

The conditions required for the material of the cushion material 15 are, firstly, the material should have elasticity (cushioning) for absorbing vibrations and shock; then, the material should not lose the physical properties even in high temperature environment such as engine room; and then, the material should be possible to withstand the heat shock caused due to temperature change from outside of the housing.

In the present embodiment, the silicone rubber having a vibration-damping properties is used. As the characteristic value to attenuate vibrations, for example, a coefficient of loss is used; however, this is because generally the rubber material such as natural rubber or butyl rubber is superior to silicone rubber.

However, these rubber materials have remarkable cleave resistance proportional to the temperature; therefore, it do not withstand for use under high temperature such as engine room.

As another thermally durable material, fluororubber or laminated paper, inorganic fibers, and the like can be used.

The cushion material 15 is composed of a silicone rubber having Shore hardness 50 A of 5 mm thickness.

Although the thickness is particularly not specified, but the thickness t=1 mm or more is required from the viewpoint of the heat insulating ability.

The thermal conductivity of the silicone rubber is generally about 0.2 W/m·K; therefore, when using the laminated papers or the inorganic fibers, the thickness can be further reduced from the viewpoint of heat conduction; however, the thickness of about 1 mm or more is required to ensure the vibration resistance.

The present embodiment has 5 mm of cushion thickness from the balance of the thermal conductivity of the heat insulating material 69 consisting 1 mm ceramic paper sandwiched between the inner cylinder 66 and the outer cylinder 81.

The thermal conductivity of the ceramic paper is approximately 0.04 W/m·K.

The thickness of the silicon rubber corresponding to 1 mm of ceramic paper for thermal conduction is therefore 5 mm.

Hereinafter, the water resistance of the aerosol fire extinguishing device 1 according to the present embodiment will be explained.

As shown in FIG. 11, the aerosol fire extinguishing device 1 according to the present embodiment having 100 g agent was submerged in a diving state by turning the device upward, downward, and sideways in a water depth of 1 m point, and allowed to stand for 30 minutes.

After standing for 30 minutes, each weight measurement, decomposition, and operation was checked for aerosol fire extinguishing device 1.

Testing methods were based on the following 3 classifications.
1. Without sealing agent
2. Filling the sealing agent (3 cc of sealing agent was filled in the seal portion 30 and 2 cc of sealing agent was filled in the seal portions 31 and 84)
3. Filling the sealing agent (1 cc of sealing agent was filled in the seal portion 30 and 0.5 cc of sealing agent was filled in the seal portions 31 and 84)

Each two specimens (one for dismantling test and one for combustion test) were used for each diving direction.

Changes in the sealing agent filling quantity and the submersion quantity, and the combustion situation are shown in Table 7.

TABLE 7
Changes in the sealing agent filling quantity and the submersion quantity, and the combustion situation

| | | | Weight difference | | |
|---|---|---|---|---|---|
| | Submersion | Sample | before and after | | Combustion |
| Waterproof method | method | No. | test (g) | Dismantling result | situation |
| 1. Without sealing agent | Upward | 1 | 22.3 | No dismantling (Subjected to | Abnormal increase |
| | | | | combustion test) | in combustion |
| | | | | | time |
| | | 2 | 26.9 | Insulating material water | Not executed for |
| | | | | absorption, agent wetting | dismantling |
| | Sideways | 3 | 31.1 | No dismantling (Subjected to | Misfire |
| | | | | combustion test) | |
| | | 4 | 34.6 | Insulating material water | Not executed for |
| | | | | absorption, agent wetting | dismantling |
| Filling the sealing agent (3 cc | Upward | 5 | 0 | No dismantling (Subjected to | Normal |
| of sealing agent was filled in | | | | combustion test) | combustion |
| the seal portion 30 and 2 cc of | | 6 | 0 | No water invasion | Not executed for |
| sealing agent was filled in the | | | | | dismantling |
| seal portions 31 and 84) | Downward | 7 | 0 | No dismantling (Subjected to | Normal |
| | | | | combustion test) | combustion |
| | | 8 | 0 | No water invasion | Not executed for |
| | | | | | dismantling |
| | Sideways | 9 | 0 | No dismantling (Subjected to | Normal |
| | | | | combustion test) | combustion |
| | | 10 | 0 | No water invasion | Not executed for |
| | | | | | dismantling |
| Filling the sealing agent (1 cc | Upward | 11 | 0 | No dismantling (Subjected to | Normal |
| of sealing agent was filled in | | | | combustion test) | combustion |
| the seal portion 30 and 0.5 cc | | 12 | 0.1 | Back drop of water at nozzle sheet | Not executed for |
| of sealing agent was filled in | | | | | dismantling |
| the seal portions 31 and 84) | Downward | 13 | 0 | No dismantling (Subjected to | Normal |
| | | | | combustion test) | combustion |
| | | 14 | 1.2 | Insulating material wetting | Not executed for |
| | | | | | dismantling |
| | Sideways | 15 | 0 | No dismantling (Subjected to | Normal |
| | | | | combustion test) | combustion |
| | | 16 | 0 | No water invasion | Not executed for |
| | | | | | dismantling |

1. Without sealing agent: Had no water resistance at the submerged level because of the caulking structure only.

2. Filling the sealing agent (appropriate quantity): By filling the sealing agent in an appropriate quantity to attach the nozzle sheet 70, the aerosol fire extinguishing device 1 according to the present embodiment was confirmed to have waterproof property (IP7 equivalent). Since the appropriate amount of sealing agent was filled, it was considered that the filling part was watertight and secondarily, had high dustproof property.

3. Filling the sealing agent (too small quantity): Since too small quantity of sealing agent was filled, interconnected cells were generated in the filling portion thereby causing inundation although in very small amount.

In this way, by filling the caulking member with the sealing agent, water resistance is imparted; thereby providing the fire extinguishing device that can withstand the use in diverse environments.

### REFERENCE NUMERALS

1 Aerosol fire extinguishing device
10 Aerosol fire extinguishing agent pellet
11, 16, 26 Fire extinguishing tool insertion hole
15 Cushion material
20 Bottom plate
21 Plate portion
22 Fire extinguishing tool mounting portion
29 Fire extinguishing tool assembly holes
30, 31, 84 Sealing portion
33 Fire extinguishing tool
34 Leg lines
35 First spacer
39 First wire netting
43 First coolant layer
44 Second wire netting
48 Second spacer
51 Third wire netting
55 Second coolant layer
56 Fourth wire netting
60 Third spacer
61 Notch portion
62 Protruding part
66 Inner cylinder
69 Heat insulating material
70 Nozzle sheet
76 Top plate
77 Nozzle
81 Outer cylinder
90 Restrictor

1. An aerosol fire extinguishing agent comprising:
an oxidizing agent, comprising 60% to 85% by weight of potassium nitrate;
a reducing agent, comprising 10% to 26.7% by weight of dicyandiamide; and
a reducing agent/binder, comprising 5% to 13.3% by weight of phenolic resin, to which a fluororubber is added in an outer percentage of 0.5 to 5 wt. %.

2. (canceled)

3. The aerosol fire extinguishing agent of claim 1, further comprising an aerosol fire extinguishing agent pellet with a generally circular disk-shaped pellet that is Dress-molded from the aerosol fire extinguishing agent, wherein a center of the pellet includes a fire extinguishing tool insertion hole, and wherein the pellet includes a restrictor made of soft rubber applied onto an outer surface of the pellet.

4. The aerosol fire extinguishing agent of claim 3, wherein the restrictor is formed on the outer surface excluding the fire extinguishing tool insertion hole of the pellet.

5. The aerosol fire extinguishing agent of claim 3, wherein the restrictor is formed on the outer surface excluding one end surface of the pellet.

6. The aerosol fire extinguishing agent of claim 3, wherein a coating thickness of the restrictor is 0.05 mm to 1 mm.

7. The aerosol fire extinguishing agent of claim 3, wherein the soft rubber is a silicone rubber.

8. The aerosol fire extinguishing agent of claim 3, wherein the pellet comprises a portion of an aerosol fire extinguishing device.

9. The aerosol fire extinguishing agent of claim 3, further comprising a bottom plate placed on one end face side of the cushion material and having a fire extinguishing tool insertion hole in the center, a fire extinguishing tool held airtightly via sealing agent in the fire extinguishing tool insertion hole of the bottom plate and having a fire extinguishing part in the fire extinguishing tool insertion hole of the aerosol fire extinguishing agent pellet, a first spacer placed on the other end face side of the aerosol fire extinguishing agent pellet, a first wire netting placed on the other end face side of the first spacer, a first coolant layer placed on the other end face side of the first wire netting, a second wire netting placed on the other end face side of the first coolant layer, a second spacer placed on the other end face side of the second wire netting, a third wire netting placed on the other end face side of the second spacer, a second coolant layer placed on the other end face side of the third wire netting, a fourth wire netting placed on the other end face side of the second coolant layer, a third spacer placed on the other end face side of the fourth wire netting and having a step-like protruding part bulging to the outside of the other end face side, an inner cylinder placed successively covering from the outside of the cushion material, outside of the aerosol fire extinguishing agent pellet, first spacer, first wire netting, first coolant layer, second wire netting, second spacer, third wire netting, second coolant layer, and fourth wire netting up to the outside of the protruding part of the third spacer, a cylindrical heat insulating material placed successively covering the outside of the inner cylinder and outside of the protruding part of the third spacer, a nozzle sheet placed on the other end face side of the third spacer and has plurality of nozzles, a top plate placed on the other end face side of the nozzle sheet, an outer cylinder placed in the outer portion of the bottom plate, cylindrical heat insulating material, nozzle sheet, and top plate, and having a caulking member caulking both ends on the bottom and top plates, a bottom plate seal part filled between the bottom plate and the caulking member, and a top plate seal part filled between the top plate and the caulking member.

10. The aerosol fire extinguishing agent of claim 9, further comprising the outer cylinder is provided with one end having a bent portion caulked onto the bottom plate, and the other end caulked onto the top plate, the bottom plate equipped with a fire extinguishing tool, the cushion material, the aerosol fire extinguishing agent pellet, the first spacer, the first wire netting, the first coolant layer, the second wire netting, the second spacer, the third wire netting, the second coolant layer, the fourth wire netting, the third spacer, the inner cylinder, the heat insulating material, the nozzle sheet, and the top plate are sequentially inserted into the outer cylinder from one end to the other end to form an internal structure, the other end of the outer cylinder is caulked onto the top plate by caulking fixture so as to prevent the generation of gaps between the internal structures, and one end of the outer cylinder having a bent portion caulked on to the bottom plate by caulking of the other end.

11. The aerosol fire extinguishing agent of claim 9, wherein the nozzle is formed in an approximately circular shape, and provided with a protrusion that protrudes to the inner diameter side.
